(19) United States
(12) Patent Application Publication
(10) Pub. No.: US 2016/0290034 A1
(43) Pub. Date: Oct. 6, 2016

(54) APPARATUS AND METHOD FOR THE ASSEMBLY OF INSULATING GLASS PANES

(71) Applicant: Plus Inventia AG, St. Gallen (CH)

(72) Inventor: Karl Lenhardt, Bad Liebenzell (DE)

(21) Appl. No.: 15/186,312

(22) Filed: Jun. 17, 2016

Related U.S. Application Data
(63) Continuation of application No. PCT/EP2014/003451, filed on Dec. 20, 2014.

(30) Foreign Application Priority Data
Dec. 20, 2013 (DE) 10 2013 021 731.8
Dec. 20, 2013 (DE) 20 2013 011 411.8

(51) Int. Cl. E06B 3/677; E06B 3/663; E06B 3/673

(52) U.S. Cl. CPC E06B 3/6775; E06B 3/67326; E06B 3/66304; E06B 3/67386; E06B 3/67373; E06B 3/67369

(57) ABSTRACT

A device for assembling insulating glass panes from glass panels includes a first horizontal conveyor having a conveying track. A rotating station is disposed downstream of the first horizontal conveyor. A second horizontal conveyor includes two conveying tracks, where the second horizontal conveyor is disposed downstream of the rotating station. An assembling and pressing station is disposed downstream of the second horizontal conveyor. The first horizontal conveyor conveys the glass panels, which are to be assembled into insulating glass panes, to the rotating station. The second horizontal conveyor conveys the glass panels from the rotating station to the assembling and pressing station. A rotatable buffer station is provided in the conveying direction of the glass panels and disposed downstream of the rotating station.

### CROSS-REFERENCE TO RELATED APPLICATIONS

This continuation application claims priority to PCT/EP2014/003451 filed on Dec. 20, 2014 which has published as WO 2015/090613 A1 and also the German application number 10 2013 021 731.8 filed on Dec. 20, 2013 and also German application number 20 2013 011 411.8 filed on Dec. 20, 2013, the entire contents of which are fully incorporated herein with these references.

### DESCRIPTION

1. Field of the Invention

The invention relates to a device for assembling insulating glass panes from glass panels, comprising a first horizontal conveyor having a conveying track, a rotating station, a second horizontal conveyor having two conveying tracks, and an assembling and pressing station, wherein the first horizontal conveyor conveys the glass panels to be assembled to form insulating glass panes to the rotating station, respectively, and the second horizontal conveyor conveys the glass panels from the rotating station to the assembling and pressing station, and a method for assembling of insulating glass panes from glass panels, wherein the glass panels are conveyed from a single-track first horizontal conveyor to a rotating station, in the rotating station a first of two glass panels forming a glass panel pair is rotated by 180° and is assembled with the second glass panel, and the thus assembled pair of glass panels is conveyed to an assembling and pressing station by a two-track second horizontal conveyor.

2. Background of the Invention

Such a device and method are known from DE 10 2012 000 464 A1 as well as from WO 2013/104542 A1 claiming the priority of said application. In these documents a device and a method for assembling insulating glass panes from glass panels is described, comprising a first horizontal conveyor having a conveying track, a rotating station, a second horizontal conveyor having two conveying tracks, and an assembling and pressing station, where the first horizontal conveyor conveys the glass panels to be assembled to form insulating glass panes to the rotating station, the rotating station pairs two glass panels and the second horizontal conveyor conveys the paired glass panels from the rotating station to the assembling and pressing station. Upstream or downstream of the rotating station a displacement station is provided, by which a glass panel conveyed by the single-track first horizontal conveyor can be moved out of the transport path and can be brought into a parking track. Following the rotating station in the conveying direction a buffering station is provided, in which two or more glass panel pairs paired in the rotating station can be moved into.

The known device is characterized by a short cycle time and hence a high production rate. By now providing that the glass panels, which are not to be assembled with the immediately preceding glass panel to an insulating glass pane, are moved out of the transport path by the displacement station and are parked in this station, the production safety of the inventive device is significantly enhanced, since it is no longer necessary, in particular when assembling triple insulating glass panes, to adhere to a complicated loading sequence of the glass panels. In fact, the glass panels to be assembled to an insulating glass pane can be placed immediately one after the other, so that the production process is simplified in an advantageous manner.

In the aforementioned DE 10 2012 025 639 A1 a rotating station being particularly suited for use in the aforementioned device is described. It has got a rotating frame with supporting walls being inclined to the vertical. A device using such a rotating station is characterized by a simple structure and a rapid way of operation, which leads to higher cycle rates when producing double- or multiple-insulating glass panes. The V-shaped design of the rotating frame with supporting walls being inclined against the vertical has got the advantage that for supporting the glass panels no additional means such as support rollers are necessary. Rather, the inclination of the supporting walls against the vertical causes that the glass panels to safely rest on the supporting walls by the effect of gravity and therefore no fixation of the glass panels is required before, during and after the rotation. In this way performance improvements, compared to the known devices, are possible, which can be two to four times.

A central component of the known device therefore is the turning station, which is used for pairing the glass panels. For that purpose, the rotating station performs, after the first glass panel was inserted, a rotation around 180°. Then the second glass panel is fed in the rotating station and the two glass panels are brought together to form a glass panel pair. From that mode of operation it follows that the length of the glass panels to be processed with the known device is limited by the length of the working area of the rotating station, since—as described before—the single glass panels must be fed into the rotating station and must be turned by it, in order to perform a pairing of corresponding glass panels.

For a number of applications it is desired that in such a device insulating glass panes of different lengths are to be produced. That means that in a kind of “tandem operation” that both “small” glass panels as well as “large” glass panels can be fed into the rotating station and can be rotated by it. This means glass panels, whose length is greater than the working space being provided in the rotating station, can be processed. If now the rotating station is dimensioned in such a way that “large” glass panels can be processed with it too, this leads to an increase of the cycle time and hence to a reduction of the production rate when processing “small” glass panels, since a rotating station being adapted for processing “large” glass panels turns slower, due to design and constructional reasons, compared to one which only can process “small” glass panels. The seemingly obvious way, simply increasing the rotation station in order to allow a tandem operation, therefore is not possible if for “small” glass panels still a high production rate is to be achieved.

DE 44 37 998 A1 describes a device for assembling of insulating glass panes from glass panels, which allows for manufacturing insulating glass panes comprising two or three glass panels. In the first case of a double insulating glass pane, firstly a first glass panel is conveyed on the first horizontal conveyor and reaches the rotating station. The glass panel moves along a supporting wall of the horizontal conveyor, which is slightly inclined, preferably by 6°, against the vertical. The rotating station has a rotating frame, which is arranged on a base element and is inclined slightly against the vertical, corresponding to the inclination of the supporting wall of the horizontal conveyor. In the latter two parallel conveying tracks are provided, which consist, respectively, of a horizontal line of synchronically driven rollers with corresponding diameters, the rotating axis thereof are lying in a common plane and are running in a rectangular angle to the supporting wall of the rotating station. For supporting the glass panels, the rotating station of the known device comprises supporting roller lines, namely one supporting roller line for the two lines of driven rollers, wherein between each of the two driven rollers there is a supporting roller protruding beyond from the upper surface of the driven rollers. One of the two conveyor tracks has a third supporting roller line, which is essentially leveled with the first two supporting roller lines, but is arranged between them in such a way, that the supporting rollers of the supporting roller line engage in spaces between the driven rollers in one of the two conveyor tracks. The supporting roller lines hence perform in the known rotating station the function of the supporting wall of the horizontal conveyor. Since the supporting roller lines of the rotating station and the supporting wall of the horizontal conveyor are aligned, i.e. are arranged at the same angle against the vertical, a glass panel can be easily conveyed from the first horizontal conveyor into the rotating station. The rotating frame moves with several wheels along a circular track on the upper surface of the base station of the rotating station, whereby the rotational entrainment is achieved, e. g. a pneumatically driven friction gear. The rotational axis of the rotating station is arranged centered in respect to the length of the rotating station and is provided approximate to the plane in which the axis of the supporting rollers of the middle supporting roller line are provided. Since the base element of the rotating station and hence the rotational axis of the rotating frame are inclined at the same angle against the vertical as the supporting wall of the horizontal conveyor, the supporting roller lines supporting the glass panels in their initial position of the rotating station are positioned, after a rotation about 180°, at the same angle as the one of the supporting wall of the horizontal conveyor in respect to the vertical, but are displaced by the double radius of the rotational movement in respect to this position. As soon as the first glass panel has arrived with its rear edge in the rotating frame, the glass panel is stopped in a predefined position and the rotating frame is rotated by 180°. The glass panel is then again arranged at the angle of the supporting wall of the horizontal conveyor in respect to the vertical, but it is not lying in the plane of the supporting wall, but spaced apart from it by the aforementioned distance. It falls with its upper edge from the first supporting roller line to the adjacent second supporting roller line and is held by this supporting roller line as it were “floating”. After the rotation movement by 180° is completed and the rotating frame of the rotating station is fixed in this position, the second glass panel provided with a spacer is conveyed in the second conveyor track of the rotating station via the first horizontal conveyor until it stands congruent with the first glass panel. The first glass panel and the second glass panel are therefore arranged parallel and spaced apart from each other.

Starting from this position the two glass panels are conveyed by the second horizontal conveyor together and at the same time into the press gap of the assembling and pressing station as soon as this one is ready and open. For this, the two glass panels are moved forward by the two conveyor belts of the second horizontal conveyor until their front ends reach the exit of the assembling and pressing station, where they are stopped in a predefined position. Then the filling of the insulating glass panes with a gas and their assembling to the final insulating glass pane is performed in a known manner. In order to assemble a triple-insulating glass pane consisting of three glass panels, it is provided, that firstly in a known manner a first and a second glass panel are assembled to a glass panel pair. At the same time, the third glass panel is conveyed in the rotating station and there rotated by 180°. As soon as the first and second glass panels are assembled, the thus formed blank is moved out of the assembling and pressing station, is stopped on a following further horizontal conveyor, and the first glass panel is there provided with a further spacer. At the same time, the third glass panel is conveyed into the assembling and pressing station on the second conveyor belt of the movable press plate. Then the blank provided with the second spacer is moved back into the assembling and pressing station and there positioned congruent with the third glass panel, is assembled with the latter, and is optionally provided with a gas heavier than air. Then the assembled triple-insulating glass pane is pressed and conveyed.

The known device has the disadvantage that it only allows very low cycle rates, since the feeding of the second glass panel of a pair of glass panels to be assembled to a double insulating glass pane to the rotating station only can be done when the first glass panel has been—as described—rotated by the rotating station around 180° and has been fixed there in its “floating” position. For that purpose, it is, as already described too, necessary that supporting roller lines for supporting the glass panel have got to be moved in position, before a rotation of the glass panel can occur. The requirement to fix the glass panel in its rotated position furthermore brings forth the disadvantage that only rectangular glass panels having the same dimensions in height and hence no freeform panels can be processed. Furthermore, it is necessary that the glass panels to be assembled to an insulating glass pane have to be loaded in a defined order.

The known device furthermore has the disadvantage that it has only a very low cycle rate and hence a minor production capacity when triple insulating glass panes are to be produced. In order to manufacture a triple insulating glass pane, the thus produced blank must be moved out of the assembling and pressing station, in order to fix a further spacer on one of the two glass panes forming the blank. Then the blank, together with the spacer attached to it, must be fed back to the assembling and pressing station, before it can be completed with a third glass panel to form the triple insulating glass pane, so that the cycle time once more increases substantially. The operation of the known rotating station is primarily to effect that a coated side of function glass panels are rotated by 180° inwardly prior to the assembling process so that thereby these coated sides are not touched. For that purpose longer cycle times are accepted. But this reduces in a disadvantageous way the production capacity of the known device.

An improvement of the device known from the aforementioned document is disclosed in EP 0 857 849 A2. This document discloses a device for assembling insulating glass panes from glass panels, comprising a horizontal conveyor, on which insulating glass panels or their corresponding blanks respectively are standing upright. A supporting unit is arranged above the horizontal conveyor; the insulating glass panels or their corresponding blanks respectively standing on the horizontal conveyor are leaning against this supporting unit. For the assembling the insulating glass panes it is provided that a first glass panel, which is supported on its first surface, is conveyed into the rotating station to a defined position on a first track of the horizontal conveyor. Then, a second glass panel is conveyed into the rotating station to a defined second position on the first track of the horizontal conveyor. Then the first and the second glass panels are transferred in the rotating station to the second track of the horizontal conveyor which is parallel to the first track. This transfer of the first and second glass panel takes place in that the rotating frame of the rotating station, which receives the glass panels, is rotated by 180° around an axis parallel to the glass panels, so that the first and second glass panel, which have been on the first conveying track before are, after the rotation, on the second conveying track of the horizontal conveyor, which extends through the rotating station. By this measure it is achieved, that the first conveying track is free for the transport of the third and fourth glass panel thereto. The third and fourth glass panel are conveyed until they both arrive on the first track of the rotating station, wherein either the first and the second or the third and the fourth glass panel bear a frame like spacer on their not supported side. The two glass panel pairs, i.e. the first and the third and the second and the fourth glass panel, are positioned spaced from each other in parallel and congruent and are conveyed simultaneously into the assembling and pressing station. This known device has—since it uses the same rotating station as the device known from DE 44 37 998 A1—the same disadvantages. In particular it has the disadvantage that it allows a production of triple insulating glass panes only in a very complicated way.

DE 10 2004 009 858 B4 describes a method and a device for positioning of pairwise oppositely arranged glass panels in a vertical assembling and pressing device, which is part of a production line for insulating glass panes. In this production line a first glass panel and a second glass panel, which has a spacer, are fed, standing on a horizontal conveyor and resting on a inclined first supporting means, to the assembling and pressing station of the production line, which has an arrangement of two pressing plates, which can be transferred from a first position, in which they are alternatingly inclined, into a second position, in which they are parallel. The first glass panel resting on the inclined supporting means is conveyed by a first section of the horizontal conveyor to a pre-defined first position, in which it is located before the assembling and pressing device, and is stopped there. Then this first glass panel is moved, transversely to the conveying direction of the horizontal conveyer, into a second position being opposite to the first position, in which it stands on the horizontal conveyor and rests on a second support means being inclined in an alternate direction, compared to the first support means. The second glass panel resting on the first support means is then conveyed to the aforementioned first position. After that, there is a simultaneous further conveying of the first and the second glass panel, wherein the glass panels rest on their respective support means and are conveyed by a second section of the horizontal conveyor, which is separated from its first section. By repeating the aforementioned steps at least once for glass panels, which are designated for the production of at least one further insulating glass pane, a second glass panel pair is formed. The first glass panel pair, which is already on the second section of the horizontal conveyor, is thereby conveyed more than the length of the following glass panel pair or glass panel pairs. The thus produced two glass panel pairs are then simultaneously conveyed by the second section of the horizontal conveyor into the open assembling and pressing device, which has got a third section of the horizontal conveyor, which can be independently moved from the second section of the horizontal conveyor, and the insulating glass pane is assembled.

### SUMMARY OF THE INVENTION

It is an object of the present invention, to further develop a device and a method as mentioned above, so that manufacturing of insulating glass panes of different lengths is possible in a simple and efficient way.

For solving this object, the inventive device provides that downstream of the rotating station a turnable buffer station is arranged.

A further solution of this object provides according to the invention that the rotating station has a rotating unit as well as at least one enlargement unit, which can be coupled to the rotating unit and is rotatable together with it in that coupled state.

The inventive method provides that for assembling further glass panels these glass panels are conveyed through the rotating station to a rotatable buffer station, that in the rotatable buffer station a first one of two glass panels constituting a glass panel pair is rotated by 180° and is subsequently paired with the second glass panel fed into the rotatable buffer station.

The inventive measures have the advantage that in an advantageous way in a single device and with a single method in a kind of “tandem operation” in a first mode of operation the manufacturing of “small” insulating glass panes and in a second mode of operation the manufacturing of “large” insulating glass panes from two or more glass panels can be achieved, without losing the advantages, which are present at the device and method mentioned at the beginning when producing “small” insulating glass panes, in particular a short cycle time and a high production rate. As is provided according to the invention that the inventive device and the inventive method are designed such that the device operates when processing “small” glass panels in the first mode of operation in the same manner as the known device and the known method, and only when processing “large” glass panels in the second mode of operation the buffer station is rotated or the rotating station is enlarged by the coupling of at least one enlargement device, the advantageous properties of the known device and the known method, when processing “small” glass panes, are fully preserved. The inventive device is only then operated in its second mode of operation, in which a rotational movement of the buffer station or the enlargement of the rotating station is performed, when it is required for processing of sufficiently large glass panels. By these measures in an advantageous way a device is created, which is characterized by a simple construction and a faster mode of operation, which results in higher cycle rates when producing double or multiple insulating glass panes.

A further advantageous improvement of the invention provides that the rotatable buffer station has a rotating frame with supporting walls which are inclined against the vertical. Such a measure has the advantage that the V-like design of the rotating frame of the rotatable buffer station with supporting walls being inclined against the vertical no further means for supporting the “large” glass panels during their processing in the rotatable buffer station provided according to the invention are required. This design brings forth that the same advantages are achieved which are present, if, according to a further improvement of the invention, the rotating station has got a rotating frame with supporting walls, which are inclined against the vertical. The V-like design of the rotating frame of the rotatable buffer station with supporting walls being inclined against the vertical has got the advantage, that for supporting of “large” glass panels, in particular in their position, in which they are rotated by 180°, no further means like support rolls, which—as described before—have got to be positioned complicatedly, are required. In fact, the inclination of the supporting walls against the vertical effects that the glass panels rest safely by the effect of gravity. Since no fixation of the glass panels before, during and after the rotation is required, the inventive buffer station operates rapidly: Immediately after feeding the first glass panel in the buffer station, the “large” glass panel resting against the first supporting wall can be rotated. After the completion of this rotating process it is possible to immediately feed the second “large” glass panel in the inventive buffer station, whereby it rests on the second supporting wall. In this way performance improvement can be achieved by “large” glass panels too, which amount to two to four times.

Preferably the rotating station arranged upstream of the rotatable buffer station is provided with V-like supporting walls too. It therefore turns more rapidly as the rotating station known from the document mentioned at the beginning, which results in higher cycle rates of the device for assembling insulating glass panes using the inventive buffer station and the V-shaped rotating station.

The V-like design of the buffer station and the V-like design of the rotating station furthermore have the advantage that not only rectangular glass panels can be processed, but freeform panels too, since for the positioning of the “large” as well as of the “small” glass panels no further devices are required. This is a particular advantage for glass panels having a sensitive coating, since by that measures during the entire manufacturing process this coating is not subject to a mechanical impact.

A further advantageous embodiment of the invention provides that at least one enlargement unit, which can be coupled to the rotating unit of the inventive rotating station, is provided with a rotating frame having supporting walls being inclined against the vertical. The advantages of the V-like design of the corresponding rotating frame described before in relation to the rotatable buffer station and the rotating station are hence achieved with the inventive rotating station comprising a central rotating unit and at least one enlargement unit.

A further advantageous embodiment of the invention provides that the rotatable buffer station comprises two conveyor tracks, which can be driven independently, and that a first conveyor track and, in the rotated state of the rotatable buffer station, the second conveyor track is aligned with the first conveyor track of the rotating station.

A further advantageous embodiment of the invention provides that the rotating station comprises two conveyor tracks, which can be driven independently, and that the first conveyor track and, in the rotated state of the rotating station, the second conveyor track is aligned with the first conveyor track of the first horizontal conveyor.

A further advantageous embodiment of the invention provides that a displacement station is arranged upstream or downstream of the rotating station, by means of which displacement station a glass panel conveyed by the single-track first horizontal conveyor is movable out of the transport path and can be brought into a parking track. By the measures according to the invention advantageously a device for assembling of insulating glass panes is provided, which is distinguished by a short cycle time and thus a high production rate. As it is now provided that glass panels, which are not to be assembled with the immediately preceding glass panels to form an insulating glass pane, are removed from the transport path of the first horizontal conveyor by the displacement station according to the invention and are parked in this station, the production rate of the inventive device and the inventive method is remarkably increased, since is not required any longer, particularly when assembling triple-insulating glass panes, to adhere to a complex order of the glass panels during their initial placement. Rather the respective glass panels, which are to be assembled to insulating glass panes, can be placed immediately one after the other, so that the production process is simplified in an advantageous manner. The inventive measures allow now that in the assembling and pressing station several glass panels are assembled to a corresponding number of insulating glass panes. The device according to the invention and the method according to the invention are particularly suited for freeform glass panels. A further advantage of the measures according to the invention is that, according to the described device and method, in particular functional glass panels, which have a coating on one surface, can be assembled to respective insulating glass panes.

A further advantageous embodiment of the invention provides that the displacement station is arranged upstream of the rotating station. According to the invention it is provided that the displacement station is arranged between the single-track first horizontal conveyor and the double-track rotating station. By this, it is achieved, that the displacement station can be made in an easy way, as the glass panel to be parked has to be removed only from one single conveying track.

A further advantageous embodiment of the invention provides that the displacement station is arranged downstream of the rotating station. Such a measure has the advantage that a short cycle time of the rotating station can be achieved, since the displacement is done after the pairing of the glass panels in the rotating station and the displacement of the corresponding glass panel can be done in an advantageous way when the required number of paired glass panels, which are assembled in the assembling and pressing station to a glass panel-pair, has been paired in the rotating station.

A further advantageous embodiment of the invention provides that the glass panel to be displaced is conveyed by the rotating station to the displacement station. Such a measure has the advantage that the displacement station can be arranged outside of the transport path of the glass panels and that the glass panel to be displaced can be moved by the rotating station to the displacement station by a rotating movement of the rotating station and a consecutive conveying. Such a measure has the advantage that in a simple way already existing devices can be upgraded.

An advantageous embodiment of the invention provides that the glass panel to be displaced is moved by the rotating station to the displacement station. Such a measure has the advantage, that the displacement station can be arranged outside the actual transport path of the glass planes and that the displacement of the glass panel can be accomplished by a rotating movement of the rotating station and a subsequent conveying of the glass panel to be displaced from the rotating station to the displacement station. Such a measure has the advantage, that herewith in a simple manner already existing devices can be upgraded.

Further advantageous embodiments of the invention are the subject matter of the dependent claims.

### BRIEF DESCRIPTION OF THE DRAWINGS

Further details and advantages of the invention are presented in the embodiments described by the Figures. There is shown:

FIGS. 1a-1d show a first exemplary embodiment of a device in a first mode of operation;

FIGS. 2a-2d show the embodiment of the aforementioned Figures in a second mode of operation;

FIGS. 3a-3d show a second exemplary embodiment of the device in a first mode of operation;

FIGS. 4a-4d show the embodiment of the FIGS. 3a-3d in a second mode of operation;

FIG. 5 shows a schematic representation of the assembling of triple insulating glass panes of “large” glass panels with the device according to the first embodiment in the first mode of operation shown in FIGS. 1a-1d;

FIG. 6 shows a schematic representation of the assembling of triple insulating glass panes of “large” glass panels with the device according to the first embodiment in the second mode of operation shown in FIGS. 2a-2d;

FIG. 7 shows a third exemplary embodiment of the device;

FIG. 8 shows a top view of the third exemplary embodiment at the position shown in FIG. 7;

FIG. 9 shows the third exemplary embodiment of FIG. 8, where the rotatable buffer station is in feeding position; and

FIG. 10 shows the third embodiment of FIG. 7, where the rotating station is in its feeding position.

### DETAILED DESCRIPTION OF THE PREFERRED EMBODIMENTS

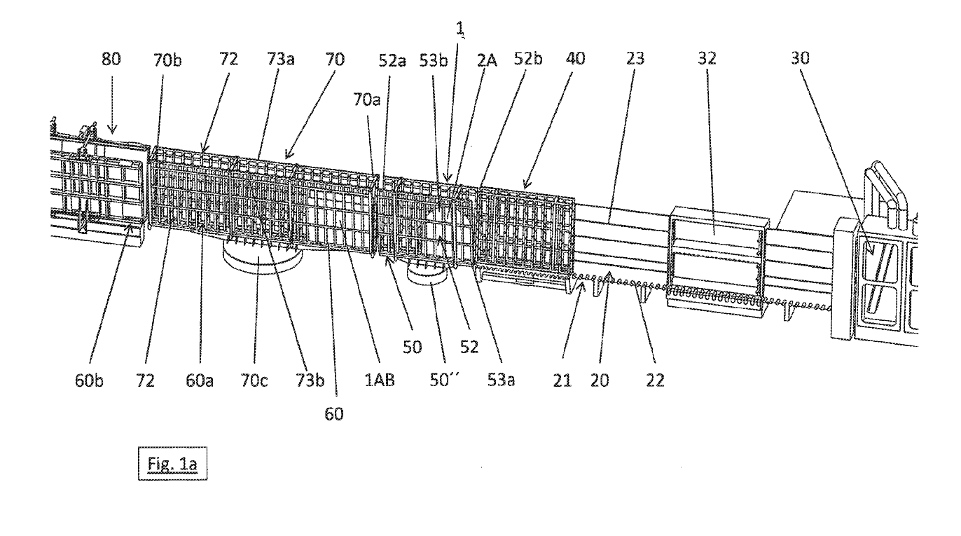

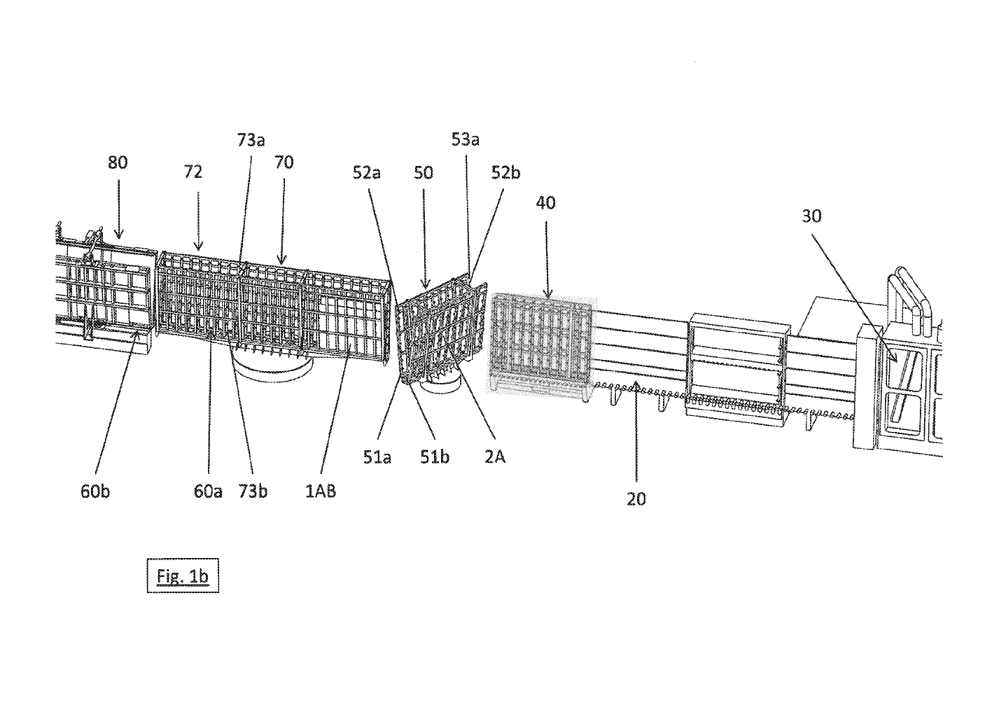

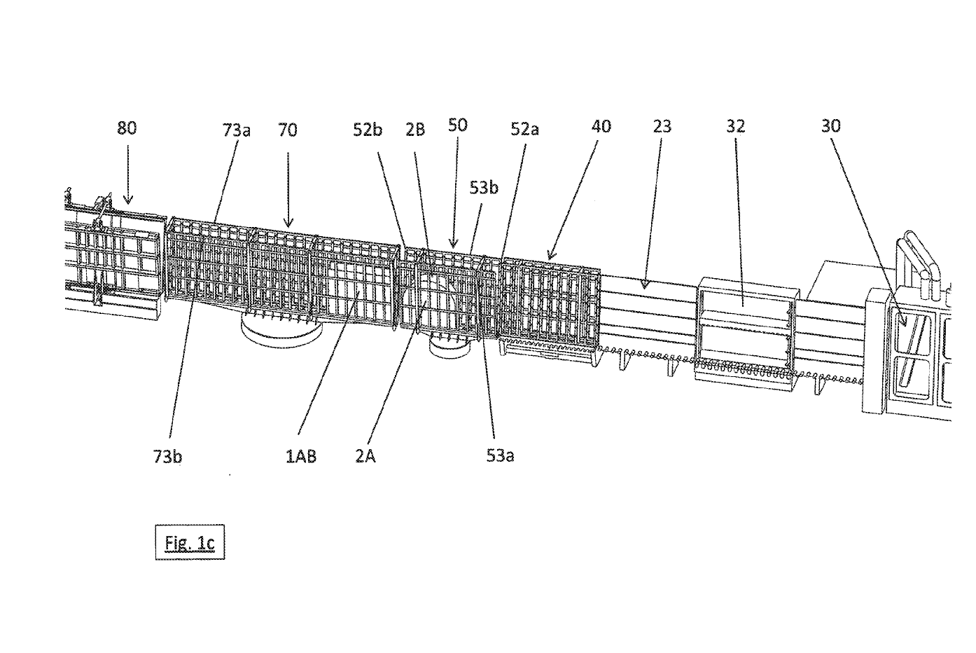

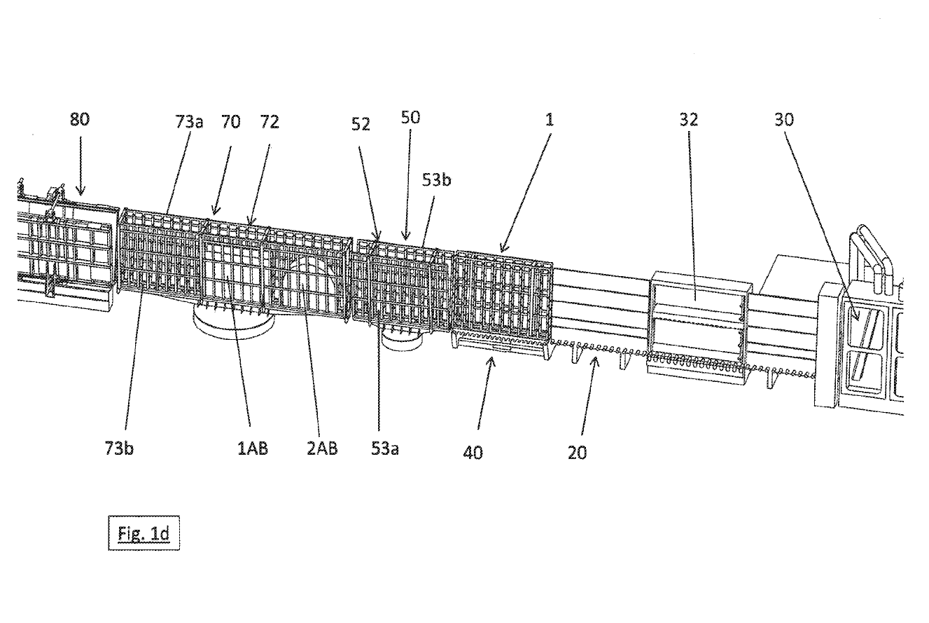

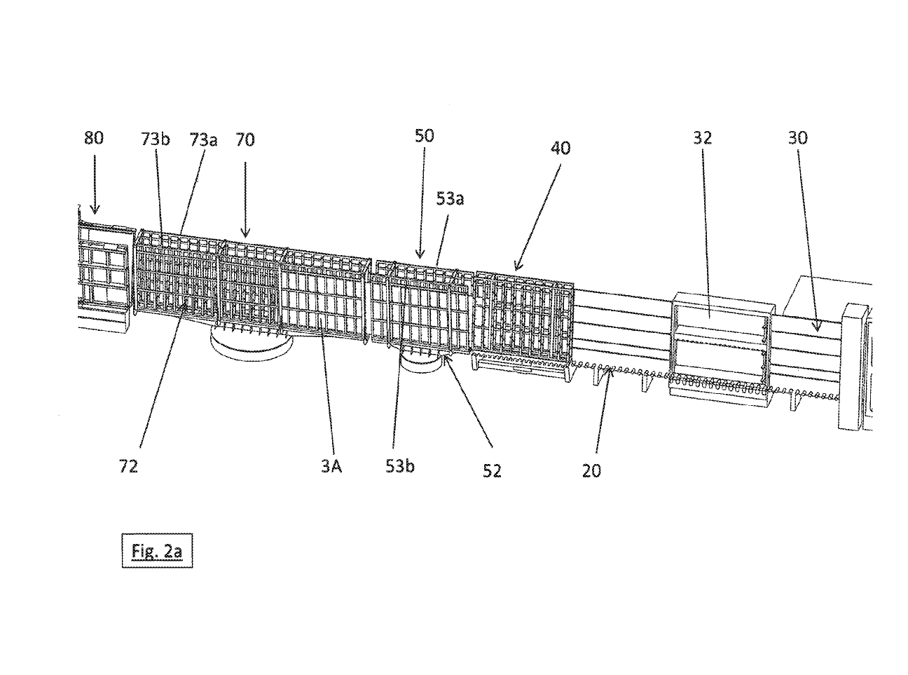

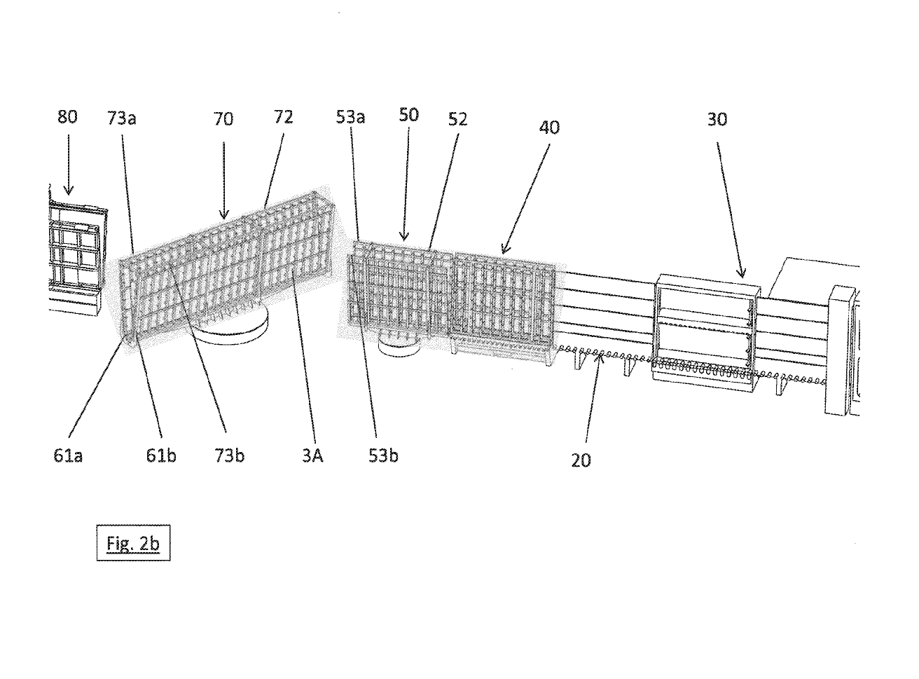

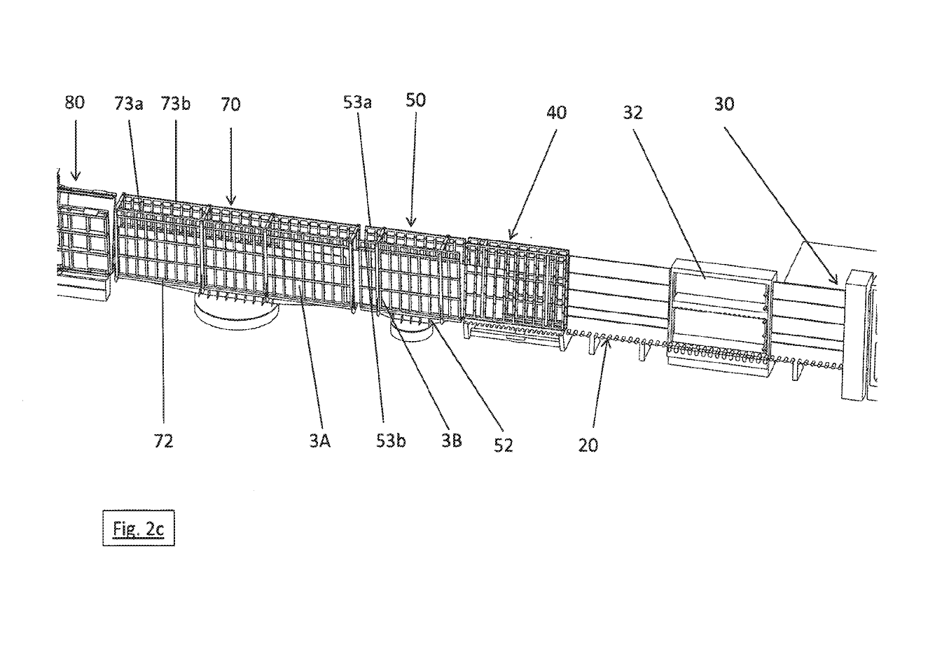

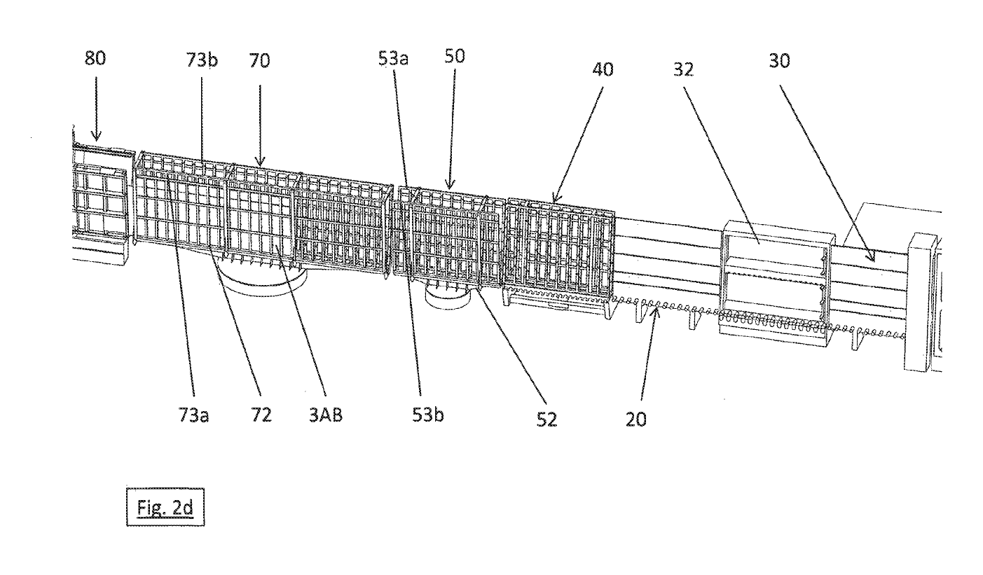

FIGS. 1a-1d and 2a-2d show an exemplary embodiment generally referenced by 1 of a device for assembling of insulating glass panes, the individual stations of which are known and are therefore not described in detail. The device 10 has a single-track first horizontal conveyor 20 having a conveying track 21. The conveying track 21 of the first horizontal conveyor 20 can be made in a known manner by a line of driven rollers 22. It is also possible to use a revolving conveyor band or a similar device. The first horizontal conveyor 20 has a supporting unit 23, which, in the described embodiment herein, is inclined towards the vertical, preferably at an angle of 6°, by which supporting unit the glass panels are supported during their transport movement. Such a horizontal conveyor 20 is known too and therefore needs not to be described in detail. It passes a cleaning station 30, in which the glass panels to be assembled for forming an insulating glass pane are cleaned. The glass panels placed in the placing station (not shown) and cleaned in the cleaning station 30 are brought by the first horizontal conveyor 20—past a checking and frame placing station 32—to a track-changing unit 40, whose design and function are described below. Downstream in a conveying direction a rotating station 50 is arranged, which has two conveyor tracks 51a and 51b, wherein the conveying track 21 of the first horizontal conveyor 20—corresponding to the rotating position of the rotating station 50—aligns either with the first conveyor track 51a or with the second conveyor track 51b, so that the glass panels on the first horizontal conveyor 20 can transferred to the conveyor track 51a or 51b of the rotating station 50 being actually aligned with the conveyor track 21. In the conveying direction a double-track second horizontal conveyor 60 is following the rotating station 50, which comprises two conveyor tracks 61a and 61b (see FIG. 2b). Those are aligned with the conveyor tracks 51a, 51b of the rotating station 50, so that glass panels located on these conveyor tracks 51a, 51b can be transferred to the conveyor tracks 61a, 61b of the second horizontal conveyor 60.

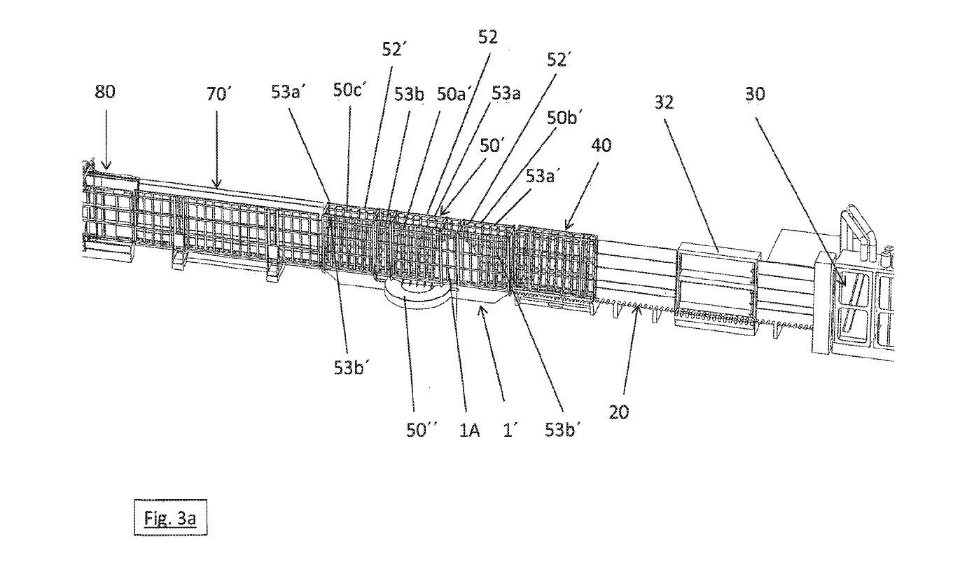

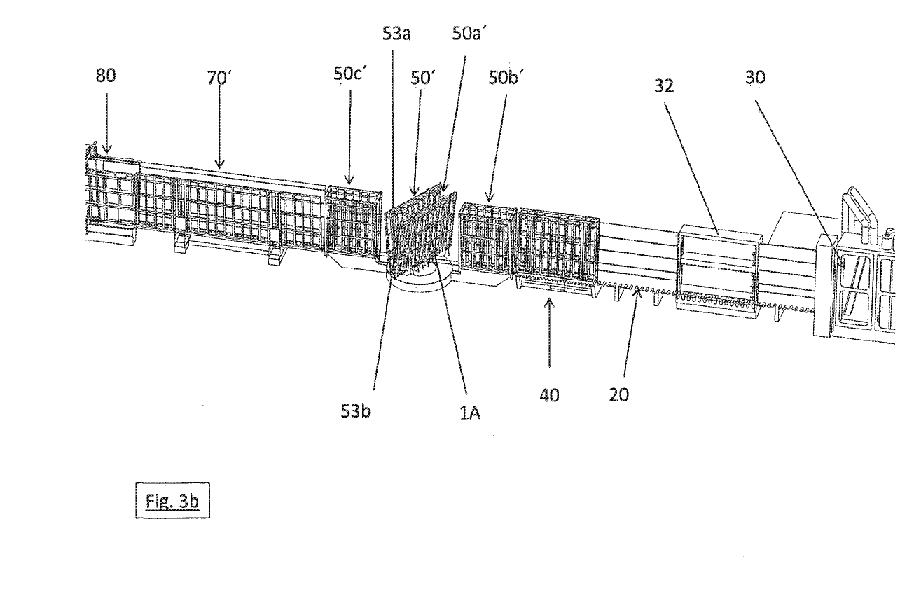

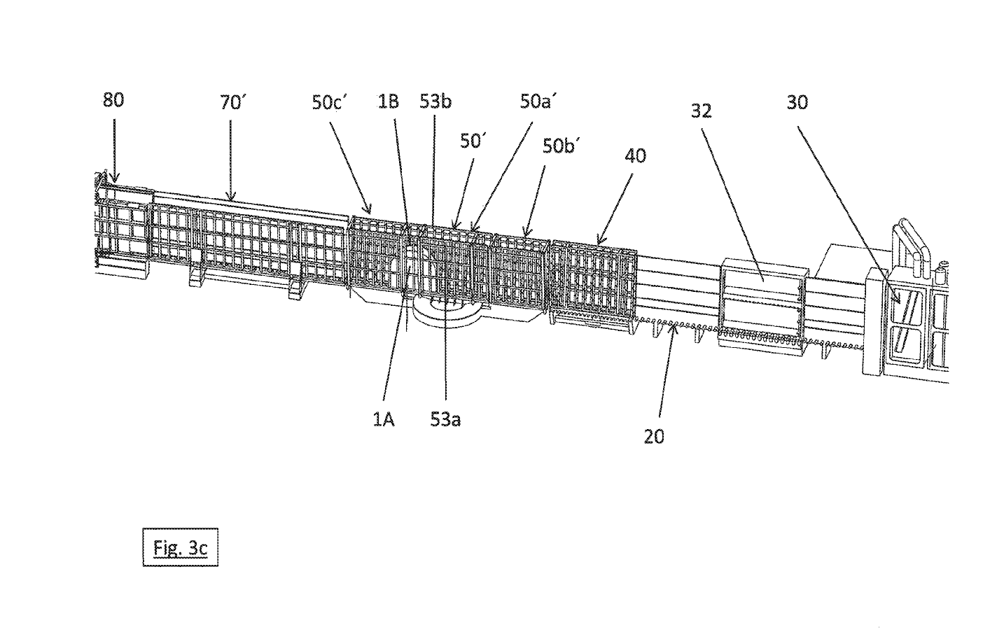

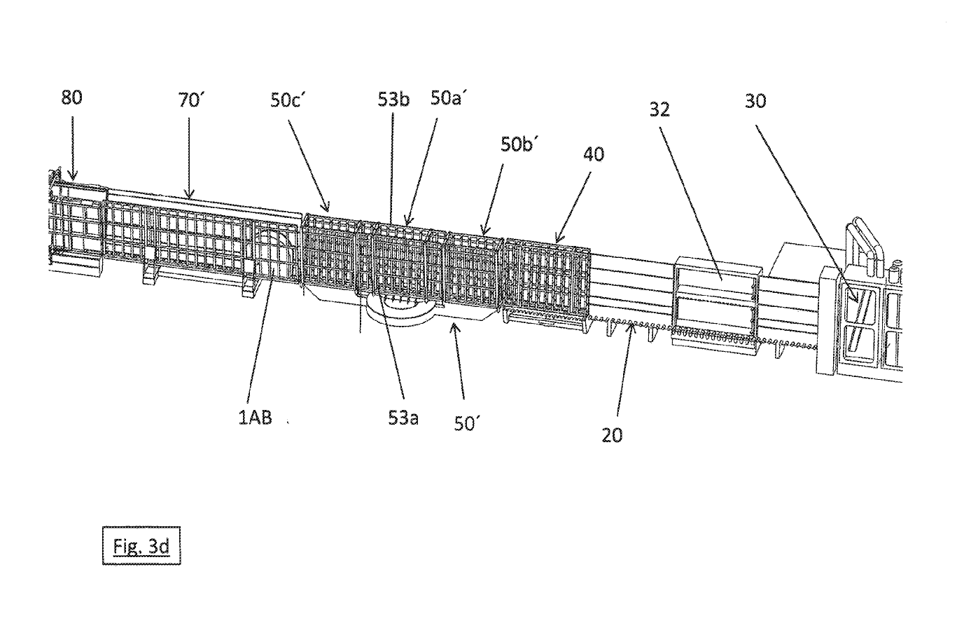

The rotating station 50, which is driven by a drive unit 50″, has got a length, which allows to load glass panes 1A, 2A, having a first length l₁. A rotating frame 52 is rotatable around an axis which is essentially orthogonal to the conveying direction of the glass panels, so that after a rotation of 180° its—in FIG. 1—front end 52a, which was facing the buffering station 70 before, then faces in this rotated state the first horizontal conveyor 20 and its second end 52b then faces the buffering station 70. The rotating frame 52, which is rotatingly drivable by a driving unit 50′, comprises—as it can be seen from FIG. 3—two supporting walls 53a and 52b, being inclined against the vertical, preferably at an angle of 6°, which have a plurality of supporting rollers (not shown), along which the glass panels can move. The glass panel supported by the first supporting wall 52a rests with its lower edge on rollers of the first conveyor track 51a and a glass panel supported by the second supporting wall 52b rests on rollers of the second conveyor track 51b. The rotating station 50 is thus made double-tracked and the rollers of the first conveyor track 51a and the rollers of the second conveyor track 51b are drivable independently from each other, so that—as described in the following—on each of the two tracks of the rotating station 50 one or more glass panels located on one of the tracks can be moved independent of the glass panels located on the other track. For further details in respect to the design and the function of the rotating frame 50 it is referred to DE 10 2012 000 464 A1, the disclosure of which is incorporated in this application by way of reference.

The second horizontal conveyor 60 comprises two sections 60a and 60b, which are preferably drivable independently from each other. The first section 60a traverses a buffering station 70 and the second section 60b traverses an assembling and pressing station 80. The design of a preferred embodiment of the buffering station 70 and the assembling and pressing station 80 are described in the international patent application WO 2005/080739, which is incorporated herewith by reference to avoid repetition and whose disclosure is made the subject matter of this application by reference. In the following the design of the buffering station 70 and the assembling and pressing station 80 are only described in so far, as it seems appropriate or necessary for the understanding of this application.

In contrast to the buffer station known from the aforementioned document the buffer station 70 of the device 1 described herein is designed rotatably, so that after rotation by 180° its front end 70a (as shown in FIG. 1), which is facing the rotating station 50, is then facing in this rotated state the assembling and pressing station 80 and its rear end 70b is facing the rotating station 50. The buffer station 70, which is driven by a rotating unit 70c, has a rotating frame 72 being driven by the rotating unit 70c, which—like the rotating frame 52 of the rotating station—has got supporting walls 73a and 73b being inclined against the vertical, preferably at an angle of 6°, which have a plurality of support rolls (not shown), along which the glass panels can be moved. The buffer station 70 has got a length, which allows to load at least one glass pane 3A, having a length l₂ with l₂>l₁, and to turn it. The glass panel supported by the first supporting wall 73a rests with its lower edge on rolls of a first conveyor 61a of the first section 60a and a glass panel supported by the second supporting wall 73b rests on rolls of a second conveyor track 61b of the first section 60a of the second horizontal conveyor. The buffer station 70 is therefore—like the rotating station 50—built dual-track and the rolls of the first conveying track 61a and of the second conveying track 61b of the first section 60a and of the second section 60b of the second horizontal conveyor 60 are preferable drivable independently from each other, so that for both of the tracks of the buffer station 70 and/or the assembling and pressing station 80 one or more glass panels being on one track can be moved independently from the glass panels being on the other track.

The general principle of operation of the device is explained with reference to the FIGS. 1a-1d. If “small” glass panels 1A, 1B and 2A, 2B are to be assembled to an insulating glass pane 1AB and 2AB respectively, this means glass panels 1A, 1B, 2A, 2B, which can be loaded into the rotating station 50 and can be turned, the rotatable buffer station 70 is operated in the first mode of operation of the device 1 in a “passive mode”, this means that it is in its basic position and performs during the processing of the “small” glass panels no rotational movement. The mode of operation of the device 1 is therefore the same as the one of the device described in the aforementioned DE 10 2012 000 464 A1 as well as in WO 2013/104542 A1.

For the sake of completeness, this mode of operation shall be described briefly with reference to the FIGS. 1a-1d: In the buffer station 70 there is a glass panel pair 1AB, being formed by two glass panels 1A and 1B, in the rotating station 50 there is a first glass panel 2A.

As shown in FIG. 1b, the rotating station 50 is turned by 180°, until it reaches its position shown in FIG. 1c. Then the second glass panel 2B is conveyed by the first horizontal conveyor 20 into the rotating station and is paired to a glass panel pair 2AB.

As shown in FIG. 1d, then the second glass panel pair 2AB is fed to the buffer station 70, whereby, during that feeding of the second glass panel pair 2AB, the first glass panel pair 1AB being already in the buffer station 70 is moved on, so that then two glass panel pairs 1AB and 2AB are in the buffer station 70. Then they are fed in a known and therefore no longer described manner by the second horizontal conveyor 60 to the assembling and pressing station 80 and are there assembled in a known way too to form a double insulating glass pane.

If now “large” glass panels 3A, 3B, i.e. glass panels 3A, 3B having a length l₂ greater than the length l₁ of the glass panels 1A, 1B, 2A, 2B, which can be turned by the rotating station 50, then one proceeds as shown in FIGS. 2c-2d: The rotating station 50 and the rotatable buffer station 70 are in their basic position shown in FIG. 2a, the supporting walls 53a and 73a as well 53b and 73b of the rotating frames 52 and 72 of the rotating station 50 and the rotatable buffer station 70 are aligned, so that a first “large” glass panel 3A—as shown in FIG. 2a—can be fed, passing rotating station 50, into the buffer station 70.

If this glass panel 3A is now—like the “small” glass panels 1A and 2A, respectively, have been fed into the rotating station 50—fed in the rotatable buffer station 70, i.e. it rests on the supporting wall 73a of the rotating frame 70, then—as shown in FIG. 2b—the rotatable buffer station 70 is rotated by 180°. It therefore assumes the position shown in FIG. 2c. It is apparent that the first glass panel 3A is now facing the viewer. Then the second glass panel 3B is fed into the rotatable buffer station 70, thereby passing the rotating station 50 being still in its basic position, and rests on the second supporting wall 73b. In this way the two “large” glass panels 3A, 3B are paired to a glass panel pair 3AB, in the same way as “small” glass panels 1A, 1B and 2A, 2B respectively have been paired to glass panel pairs 1AB and 2AB respectively. The glass panel pair 3AB then is fed in a known manner by the first section 60a of the second horizontal conveyor 60 and the second section 60b traversing the assembling and pressing station 80 into this station and is assembled in a known manner to form a double-insulating glass pane.

As it is evident from the afore description, the rotatable buffer station 70 serves, when assembling “small” glass panels 1A, 1B as well as 2A, 2B to glass panel pairs 1AB and 2AB respectively, to buffer these glass panel pairs, before they are fed together into the assembling and pressing station 80. The buffer station 70 therefore has got a length, which is dimensioned such that not only “large” glass panels 3A, 3B, which have a length l₂, can be processed, but that in it at least two “small” glass panel pairs 1AB, 2AB, which have a length l₁, can be accommodated in it. Of course it is possible to design the buffer station 70 in such a way that more than two glass panel pairs 1AB, 2AB, which each have the length l₁, can be accommodated in it. In the embodiment described here the buffer station 70 has got a length which allows the loading of three glass panel pairs 1AB, 2AB, each having a length of l₁, as well as of “large” glass panels 3A, 3B, having a length up to l₂=3 l₁. From the afore description it is evident for a person skilled in the art that the dimensioning of the length of the rotatable buffer station 70 shown in the Figures and described is only of an exemplary nature. It is preferred that the rotatable buffer station 70 is designed for the loading of two “small” glass panel pairs 1AB, 2AB each having a length l₁ as well as of a “large” glass panel pair 3AB with a length l₂=2 l₁.

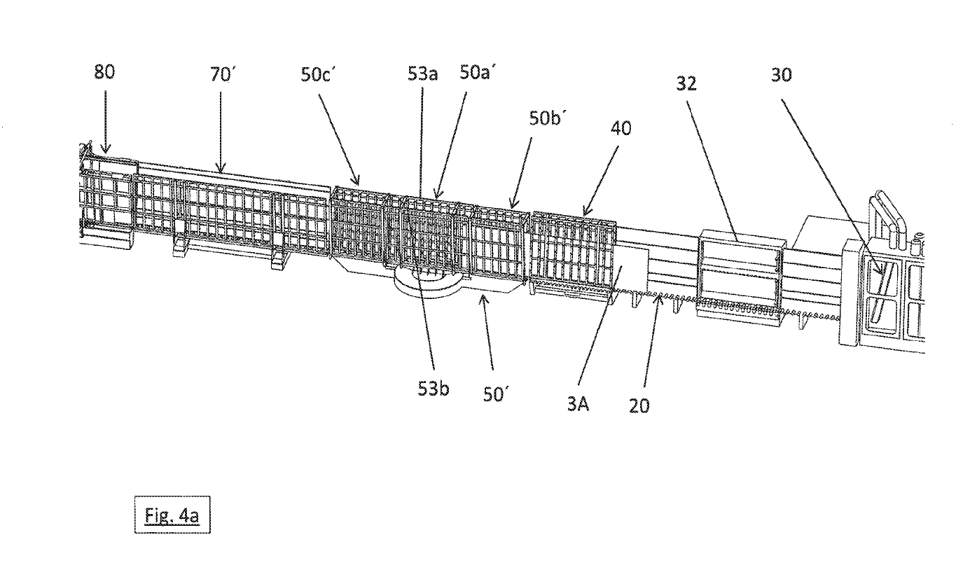

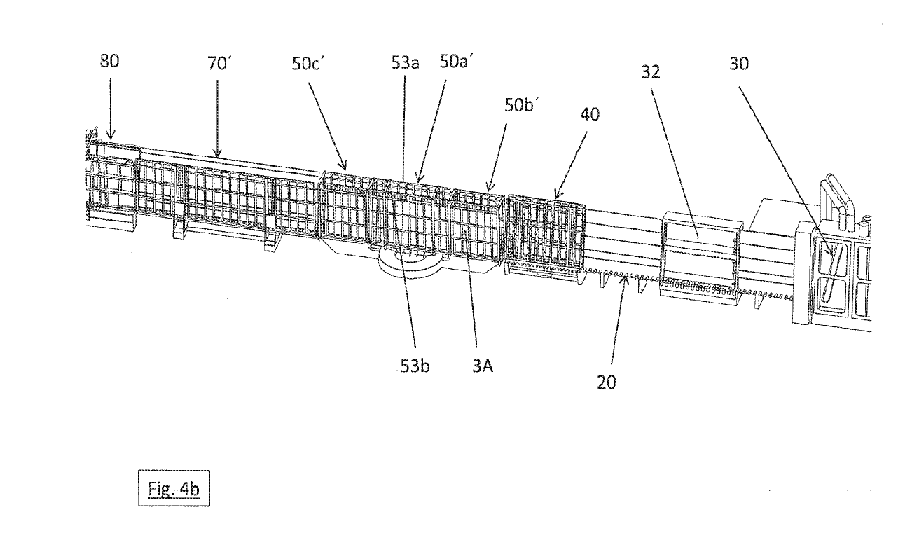

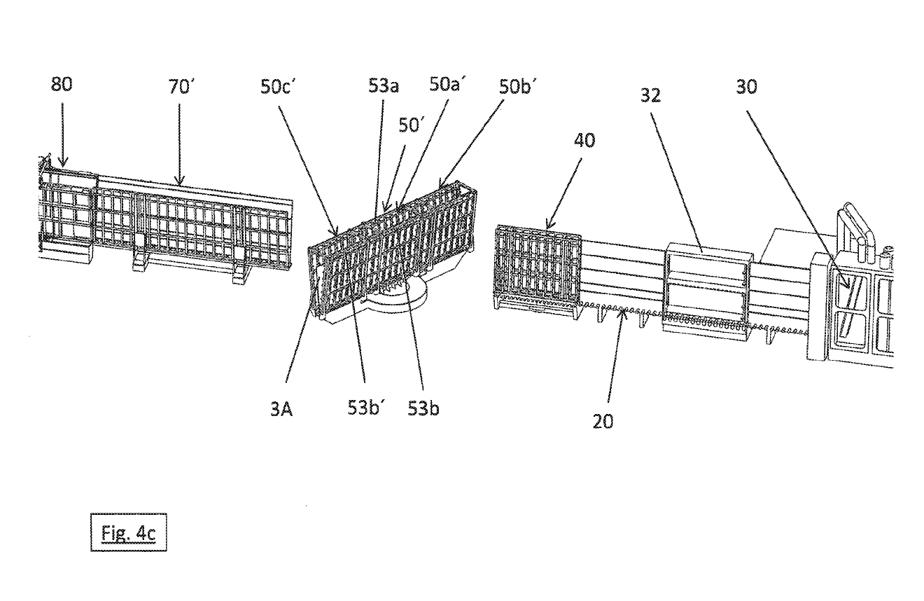

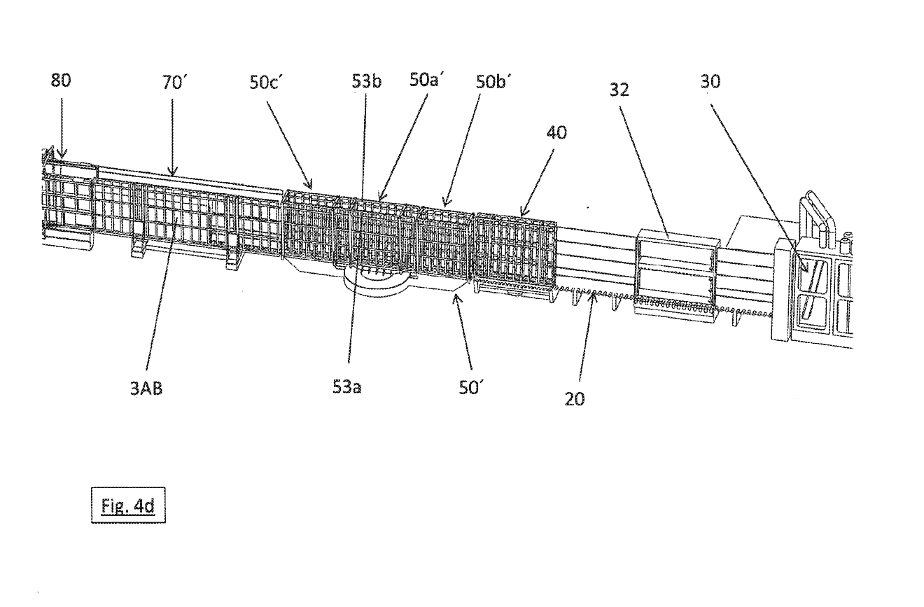

In FIGS. 3a-3d and 4a-4d now a second exemplary embodiment of a device 1′ is shown, wherein corresponding stations and components are denoted with the same reference signs and are not described any further in detail.

The device 1′ of the second exemplary embodiment has got a buffer station 70′, which is—in contrast to the rotatable buffer station 70 of the first exemplary embodiment—not necessarily designed rotatable, but is, in the exemplary embodiment described, designed stationary. It is evident for the person skilled in the art from the following description that this buffer station 70′, which is arranged between a rotating station 50′ corresponding the rotating station 50 of the first embodiment, and the assembling and pressing station 80, is of advantage for an efficient production process, but not mandatory and therefore can optionally be omitted.

The essential difference between the two exemplary embodiments is that in the device 1′ of the second exemplary embodiment the rotating station 50′ performs the function of the rotatable buffer station 70 of the first embodiment too, i.e. it is designed such that it allows both the rotating of “small” glass panels 1A, 1B, 2A, 2B, having a length l₁, and the one of “large” glass panels 3A, 3B, having a length l₂>l₁. For that purpose it is provided that the rotating station 50′ has a rotating unit 50a′, which is designed like the rotating station 50 of the first embodiment and is therefore not described any further. The main design difference between the rotating station 50′ of the second embodiment and the rotating station 50 of the first embodiment is that the rotating station 50′ has got at least one, in the embodiment described here, two connectable enlargement units 50b′ and 50c′, which can be coupled to the rotating station 50′ and enlarge the rotating unit 50a′ in such an amount that “large” glass panels 3A, 3B can be rotated with it. In the described embodiment the enlargement units 50b′, 50c′ are arranged on both sides of the rotating unit 50a′ respectively. But it is possible to provide only one enlargement unit on one side of the rotating unit 50a′, which then has got to be dimensioned appropriately. But this solution is not preferred, since it results in an asymmetric design of the rotating station 50′.

Each of the two enlargement units 50b′ and 50c′ preferably has got a frame 52′ with supporting walls 53a′ and 53b′ respectively, which are inclined against the vertical and are aligned with the supporting walls 53a, 53b of the rotating frame 52 of the rotating station 50a′.

The operation of the device 1′ of the second exemplary embodiment is now as follows: If “small” glass panels are to be processed by the device 1′, then the two enlargement units 50b′ and 50c′ are disconnected from the rotating unit 50a′, as shown in FIG. 3a. In this first mode of operation of the device 1′ therefore only the rotating unit 50a′ of the rotating station 50′ rotates. This corresponds to the operation of the rotating station 50 of the first embodiment. A first glass panel 1A is—as described before—fed through the first enlargement unit 50b′ into the rotating unit 50a′, which then is turned by 180°. Then the second glass panel 1B, once more fed through the first enlargement 50b′ being disconnected from the rotating unit 50a′, is fed into the rotating unit 50a′ and is paired in it to form the glass panel pair 1AB. This is then conveyed—as shown in FIG. 3c—through the second enlargement unit 50c being disconnected from the rotating station 50a′ to the buffer station 70′ or—if this one is not provided, as described before—directly to the assembling and pressing station 80 (see FIG. 3d).

In order to be able to rotate “large” glass panels 3A, 3B in the rotating station 50′ too, it is now provided—as shown in FIG. 4a—that the enlargement units 50b′ and 50c′ are coupled to the rotating unit 50a′, so that these two enlargement units 50b′ and 50c′ can be rotated together with the rotating unit 50a′. A first glass panel 3A is then fed—like the “small” glass panels 1A and 2A respectively are fed into the rotating station 50—in the thus enlarged rotating station 50a (FIG. 4b). The rotating station 50′ is then—as can be seen from FIG. 4c—rotated by 180°. Then the second glass panel 3B is fed into the rotating station 50′, and the glass panel pair 3AB is formed. This is then conveyed—as shown in FIG. 4d—through the buffer station 70′ or directly to the assembling and pressing station 80.

The two afore-described devices 1 and 1′ therefore allow in an advantageous manner by virtue of the two aforementioned modes of operation a “tandem operation”, in which in a single production line both “small” glass panels 1A-2B, i.e. glass panels having the length l₁, which can be fed into the rotating station 50 and rotation station 50′ respectively and can be turned in it, as well as “large” glass panels 3A, 3B, i.e. glass panels having the length l₂>l₁, which do not fit into the rotating station 50 and the rotating station 50′ respectively, without that in this way, in particular when processing the aforementioned “small” glass panels a reduced efficiency, in particular a higher cycle time, occurs, when compared to the device known from DE 10 2012 000 464 A1 and WO 2013/104542 A1 respectively.

Further details of the devices 1 and 1′ are now described in the following: Before the glass panels are transported from the cleaning station 30 to the rotating station 50 by the first horizontal conveyor 20, they move through the displacement station 40. It is the object of the displacement station 40 to displace a glass panel located on the conveyor track 21 of the first horizontal conveyor 20, so that a further glass panel situated behind this glass panel can be conveyed from the cleaning station 30 to the rotating station 50 by the first horizontal conveyor 20. The displacement station 40 therefore transfers a glass panel being in this displacement station 40 from the first track made up by the conveyor track 21 of the horizontal conveyor 20 to a second track, in which the such moved glass panel can be “parked”. For further details in respect to this displacement station 40, it is referred to the aforementioned patent applications DE 10 201 2 000 464 A1 and WO 2013/104542 A1. This displacement station 40 is of particular advantage if the described devices 1, 1′ are not only to manufacture double-insulating glass panes, but in particular triple-insulating glass panes too.

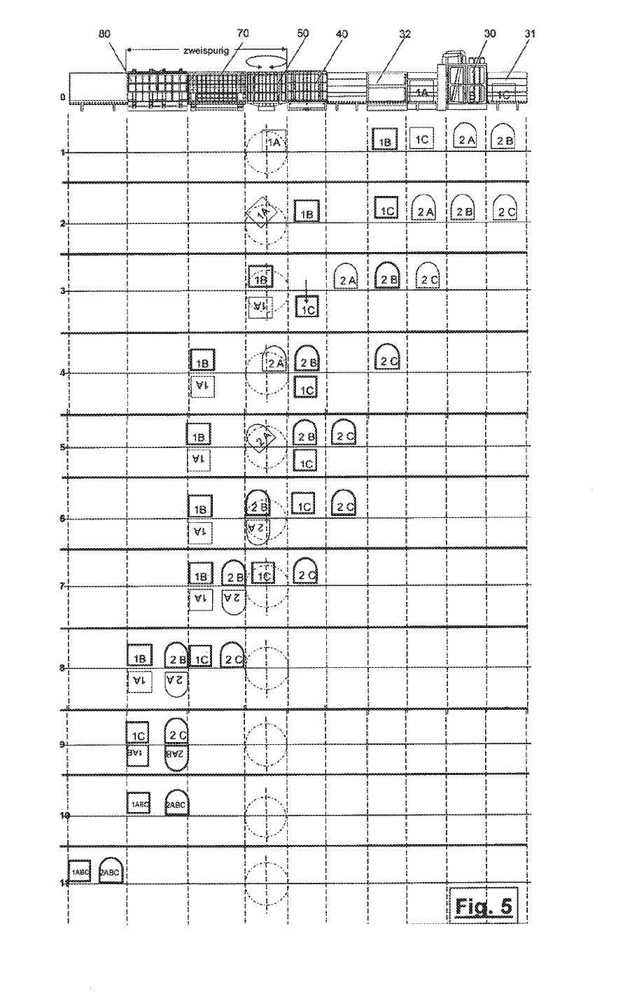

The aforementioned description assumes that double-insulating glass panes are to be assembled from “small” glass panels 1A, 1B and 2A, 2B and from “large” glass panels 3A, 3B. In fact, it is possible to manufacture triple- or multiple-insulating glass panes with the devices 1 and 1′ respectively. For “small” glass panels 1A, 1B and 2A, 2B, which are to be assembled with further glass panels 1C and 2C respectively to form triple-insulating glass panes, this is done in the first mode of operation of the devices 1 and 1′ respectively, in which the buffer station 70 and 70′ respectively are operated in their “passive mode”, for the case of the buffer station 70 as described in DE 10 2012 000 464 A1 and WO 2013/104542 A1 and shown in FIG. 5: After two glass panels 1A, 1B and 2A, 2B respectively are paired in the rotating station 50 and are fed into the buffer station 70 (lines 1 to 7 of FIG. 5), these glass panels 1A, 1B and 2A, 2B are conveyed by the second horizontal conveyor 60 into the assembling and pressing station 80 (line 8). After an assembling of these glass panels 1A, 1B and 2A, 2B to form a glass panel pair 1AB and 2AB, i.e. to form a first element of the triple insulating glass pane to be assembled, then the thus formed elements are stored on the side of the assembling and pressing station 80 associated to the second conveyor track 61b of the second horizontal conveyor. Then the third glass panels 1C and 2C are conveyed through the rotating station 50 and the rotatable buffer station 70 on the first conveyor track 61a of the second horizontal conveyor 60 to the assembling and pressing station 80, and are positioned opposite to the glass panel pairs 1AB and 2AB already there (line 9) and are then assembled by means of an appropriate operation of the assembling and pressing station 80 to form the “small” insulating glass panes 1ABC, 2ABC (line 10). For further details reference is made to the aforementioned documents DE 10 2012 000 464 A1 and WO 2013/104542 A1 respectively.

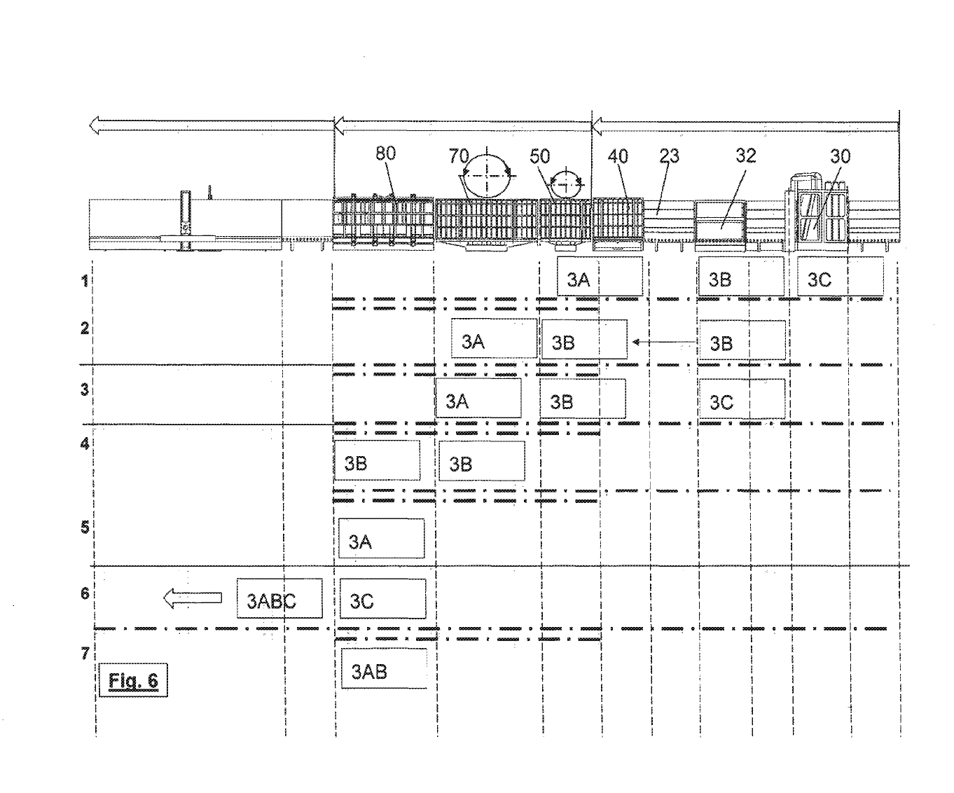

In order to assemble “large” glass panels 3A, 3B and a further “large” glass panel 3C to an triple insulating glass pane, then—as shown in the scheme of FIG. 6—first the two “large” glass panels 3A and 3B are paired in the rotatable buffer station 70 of the device 1, as described before (see lines 1 to 3 of FIG. 6). The two glass panels 3A and 3B are then conveyed by the two conveying tracks 61a and 61b of the second horizontal conveyor 60 to the assembling and pressing station 80, are there paired to form a glass panel pair 3AB and are stored on the side of the assembling and pressing station 80 associated to the second conveying track 61b. Then the further “large” glass panel 3C is conveyed through the rotating station 50, which is in its “passive mode” in this second mode of operation of the device 1, as well as through the rotatable buffer station 70 on the first track 61a of the second horizontal conveyor 60 to the assembling and pressing station 80 and is there paired with the glass panel pair 3AB, which is already there, to form a “large” triple insulating glass pane 3ABC (lines 4 to 7).

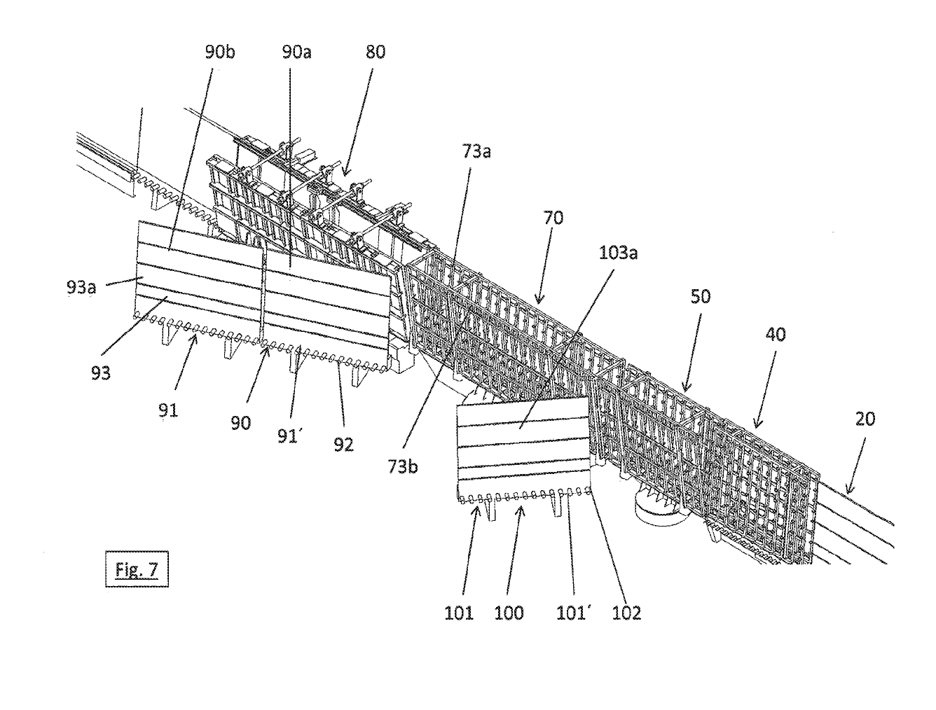

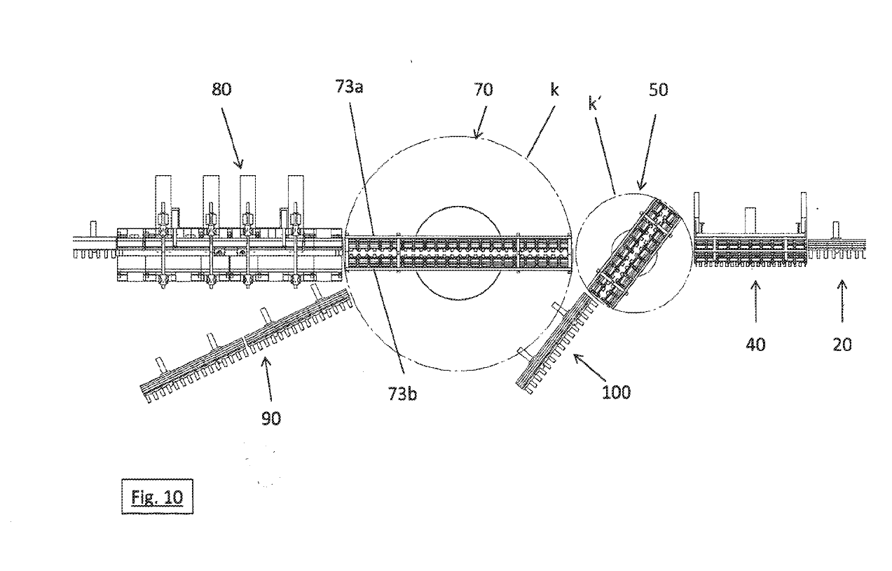

The described device is not only particularly suited for an efficient production of insulating glass panes of different length, but allows it in an advantageous way too to improve their manufacturing, in that, according to a third exemplary embodiment shown in FIGS. 7 to 10, a loading and/or unloading of single glass panes can be carried out. The third embodiment corresponds in its basic design to the one of the first of the two afore described exemplary embodiments, so that corresponding components are denoted with the same reference signs and are not described in detail any more.

It is provided that the rotatable buffer station 70 of the device 1 is associated with a loading and/or unloading station, in the following: loading station 90. This loading station 90 serves to remove single glass panels 1A-3B out of the transport track, if it is desired or required due to manufacturing reasons. In particular defect glass panels 1A-3B or glass panels, which, for other reasons, have got to be removed out of the transport path leading to the assembling and pressing station 80, can be unloaded. The third exemplary embodiment of the device 1 therefore allows an individual unloading of a glass panel 1A-3B being in the transport path, which is described in the following in detail. In this way the production process is accelerated, since in this way it is no longer necessary—unlike in the known devices—to “empty” the device 1 in a way that all glass panels preceding the glass panel to be unloaded have to be conveyed to the assembling and pressing station 80 and have to be assembled there, before the defect or for other reasons to be removed glass panel can be unloaded from the device 1, by moving it through the assembling and pressing station 80.

As it is evident from the following description too, it is—preferably—possible too, that by the loading station 90 single glass panels 1A-3B can be fed into the buffer station 70. Such measure is of particular advantage when, e. g. special glass panes with a special, in particular sensitive coating, have got to be processed, which should not, due to their sensitivity or for other reasons, run through the entire transport path between the loading station 20 and the buffer station 70.

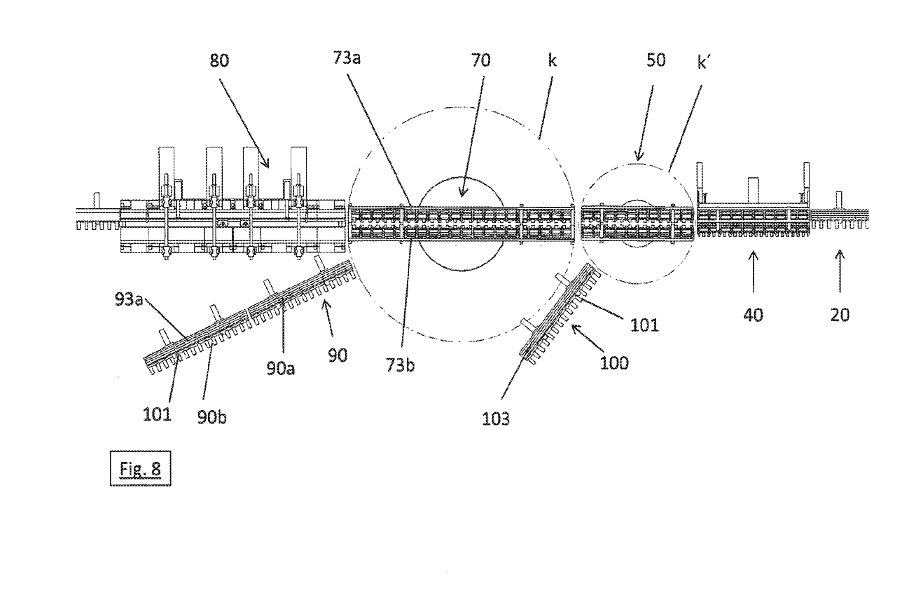

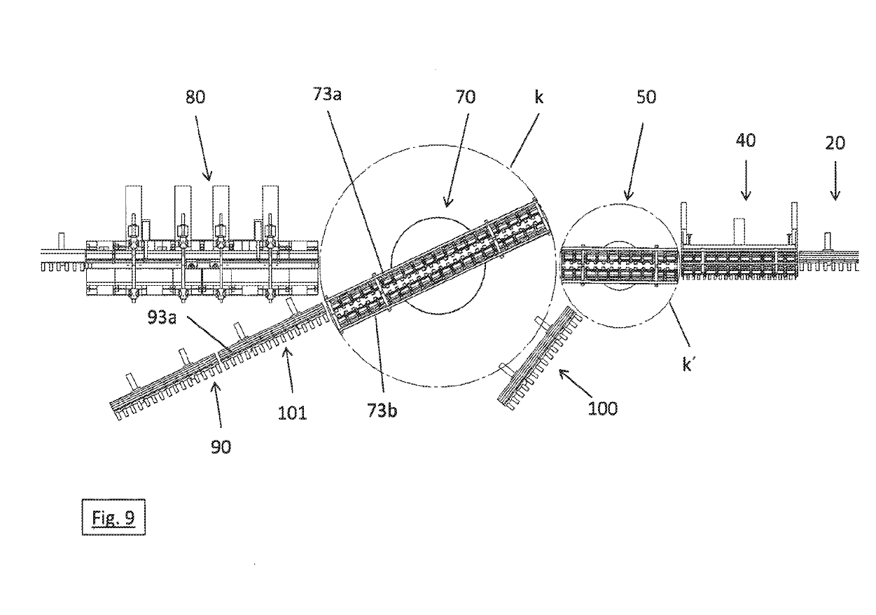

In order to accomplish the unloading and/or preferably the loading of a glass pane out of or into the transport path of the glass panels respectively, it is provided that—as it can be seen from FIG. 9—the loading station 90 is arranged on a rotating circle K of the rotatable buffer station 70 in such a way that in an unloading position of the buffer station 70 the glass panel contained in it and to be unloaded can be transferred from the buffer station 70 to the loading station 90. For that purpose the buffer station 70 is rotated from its basic position shown in FIGS. 7 and 8, in which the buffer station 70 is in the transport path of the glass panels 1A-3B—as described before—in a unloading position shown in FIG. 9. There the rotatable buffer station 70 is aligned in such a way that one or more glass panels 1A-3B can be transferred to the loading station 90.

In the embodiment described here the loading station 90 has got—as shown in FIG. 7—a horizontal conveyor 91 with a conveyor track 91′, which is formed—like the conveying track 21 of the first horizontal conveyor 20—by a line of drive rolls 92. But it is possible here too to use for the formation of the conveyor track 91′ a revolving belt or a similar installation. The loading station 90 has a support unit 93, which has got—in the case described here—a supporting wall 93a, which has a plurality of support rolls (not shown), along which the glass panels can move. The glass panel supported by the supporting wall 93a rests with its lower edge on the rolls 92 of the conveyor track 91′ of the horizontal conveyor 91. The design of the supporting wall 93a corresponds to the one of the supporting wall 73a of the buffer station 70 and is inclined against the vertical too, so that in the loading/unloading position of the buffer station 70 the supporting wall 93a aligns with the respective supporting wall 73a and 73b respectively of the buffer station 70. The glass panel to be unloaded therefore can be moved along the supporting wall 73a and 73b respectively to the supporting wall 93 of the loading station 90.

In the exemplary embodiment described the loading station 90 comprises two units 90a and 90b, which are designed as described before. But this is not mandatory. In fact, it is possible to design the supporting wall 93a and the conveyor track 91′ in an integral way.

Above it has been assumed that the support unit 93 has got a supporting wall 93a with support rolls. This is not mandatory. In fact, it is possible to use instead of the transport rolls an air cushion or similar means which effect that the glass panels 1A-3B are supported during their movement by the conveyor track 91′.

If now one glass panel, e. g. the glass panel 3A, which is on the first conveyor track 61a of the first section 60a of the second horizontal conveyor 60 and rests on the supporting wall 73b of the rotatable buffer station 70, is to be transferred into the loading station 90, then the rotatable buffer station 70 is turned, until the first supporting wall 73a is aligned with the supporting wall 93a of the loading station 90. The first conveyor track 61a of the rotatable buffer station 70 and the conveyor track 91′ of the horizontal conveyor 91 of the loading station 90 then move this glass panel 3A out of the rotatable buffer station 70 and into the loading station 90, so that it is moved out of the transport path of the device 1.

Since—as described in the following—the glass panels 1A-3B have been brought in the rotatable buffer station 70 in an already paired state, it is for a plurality of applications necessary or at least preferable, to remove a further glass panel from the rotatable buffer station 70 and hence from the device 1. If now, e. g. a glass panel 3B, which is correlated with glass panel 3A, which is on the second conveyor track 61b of the first section 60a of the second horizontal conveyor 60 and supported by the second supporting wall 73b of the rotatable buffer station 70, is to be unloaded from the device 1, then the rotatable buffer station 70 is turned in such a way that the second supporting wall 73b is aligned with the supporting wall 93a of the loading station 90. The unloading of this second glass panel 3B then is accomplished in the same way as the afore-described unloading of the first glass panel 3A.

The aforementioned description assumes that the loading station 90 has a single track, e. g. that the horizontal conveyor 91 only has got a one conveying conveyor track 91a. The afore description of the unloading of the second glass panel 3B shows that it can be advisable, too, that simultaneously or consecutively two glass panels being on different conveyor tracks 61a and 61b respectively are to be unloaded. For that purpose it is of advantage that the loading station 90 is of a dual-track nature. It then has got—not shown in the Figures—a further conveyor track as well as a further support means, which correspond to the conveyor 91a and the support unit 93. The supporting wall 93a is then arranged V-shaped too. In the loading position of the rotatable buffer station 70 the first supporting wall 73a aligns with the supporting wall 93a and the second supporting wall 73b aligns with a further supporting wall. This allows to simultaneously transfer two glass panels 3A, 3B, each of them being on one conveyor track 61a and 61b in the buffer station 70, into the loading station 90.

The described exemplary embodiment assumes that by means of the buffer station 70 and the loading station 90 large glass panels 3A, 3B can be unloaded. As a consequence, the loading station 90 has a length which corresponds to the length of the buffer station 70, so that “large” glass panels 3A, 3B can be received in the loading station 90. If for particular applications only “small” glass panels 1A-2B are to be unloaded, it is of course not necessary that the loading station 90 has got the afore-described length. In this case it is sufficient that the loading station 90 only has got one of the two units 90a and 90b.

For loading a glass panel 1A-3B into the buffer station 70, one proceeds as follows: The glass panel to be loaded is put into the loading station 90. Then the buffer station 70 is moved in its loading position, so that the rotatable buffer station 70 and the loading station 90 are aligned. Then the conveyor track 91′ of the horizontal conveyor 91 of the loading station 90 conveys the glass panel into the rotatable buffer station 70.

Preferably it can be provided that the device 1 has got a further loading station 100, which is associated to the rotating station 50 and is arranged on a rotating circle K′ of it. It then serves for unloading of glass panels 1A-2B from the rotating station 50. The further unloading station 100 has got a horizontal conveyor 101, which has a conveyor track 101′ with rolls 102. A support unit 103 with a support roll 103a is provided, which has support rolls (not shown). The supporting wall 103a of the support unit 103 are inclined in respect to the vertical too, so that they align with co-operating supporting walls 53a and 53b of the rotating station 50 respectively. The further loading station 100 is therefore designed corresponding to the loading station 90, so that a further description is not necessary. The loading and/or unloading of a glass panel into and in the rotating station 50 respectively is done in the same way as the loading and/or unloading of a glass panel out of the rotatable buffer station 70.

The aforementioned description of the further loading station 100 furthermore assumes that this is designed—like the loading station 90 shown in FIGS. 7 to 10—in a single-track way. In fact, it is—like the afore-described loading station 90—possible too to design the further loading station 100 dual-tracked, so that it then has got two conveyor tracks and two support units, which are preferably arranged in an alternate way inclined in respect to the vertical, so that a V-like design is once more given. In the loading position of the loading station 90 then one of the two supporting walls 53a and 53b respectively aligns with the supporting wall 103 and the second supporting wall 53b and 53a respectively with the further supporting wall. The explanations made in respect to the dual-track formation of the loading station 90 apply mutatis mutandis for the further loading station 100.

The described device also can be designed corresponding to the second exemplary embodiment, i.e. that the rotating station 50 is enlargeable, in order to process large glass panels 3A, 3B too, as described for the second exemplary embodiment. In this case it is of advantage that the second loading station 100 preferably has got the length allowing the unloading of large glass panels 3A, 3B too. It then corresponds in its design and function the one of the loading station 90. The turning circle K′ of the rotating station 50′ is then given by its length plus the length of one or preferably both enlargement units 50b′ and 50c′.

What is claimed is:

1. A device for assembling insulating glass panes from glass panels, the device comprising:
a first horizontal conveyor having a conveying single-track;
a rotating station disposed downstream of the first horizontal conveyor;
a second horizontal conveyor having two conveying tracks, the second horizontal conveyor disposed downstream of the rotating station;
an assembling and pressing station disposed downstream of the second horizontal conveyor;
wherein the first horizontal conveyor conveys the glass panels, which are to be assembled into insulating glass panes, to the rotating station;
wherein the second horizontal conveyor conveys the glass panels from the rotating station to the assembling and pressing station; and
a rotatable buffer station provided in the conveying direction of the glass panels disposed downstream of the rotating station.

2. The device according to claim 1, wherein the rotatable buffer station includes a rotating frame with supporting walls which are inclined against the vertical.

3. The device according to claim 1, wherein the rotatable buffer station includes two conveyor tracks which are independently drivable.

4. The device according to claim 1, including a displacement station arranged upstream or downstream of the rotating station by which a glass panel conveyed by the single-track first horizontal conveyor can be moved out of the transport path and can be brought into a parking track enabling a bypassing of a following glass panel.

5. The device according to claim 1, wherein the first conveying track and the second conveying track of the second horizontal conveyor can be driven independently.

6. The device according to claim 1, including a loading station which is assigned to the rotatable buffer station.

7. The device according to claim 1, including a loading station which is assigned to the rotating station.

8. A device for assembling insulating glass panes from glass panels, the device comprising:
a first horizontal conveyor having a conveying single-track;
a rotating station disposed downstream of the first horizontal conveyor;
a second horizontal conveyor having two conveying tracks, the second horizontal conveyor disposed downstream of the rotating station;
an assembling and pressing station disposed downstream of the second horizontal conveyor;
wherein the first horizontal conveyor conveys the glass panels, which are to be assembled to insulating glass panes, to the rotating station;
wherein the second horizontal conveyor conveys the glass panels from the rotating station to the assembling and pressing station;
wherein the rotating station comprises a rotating unit and at least one enlargement unit, wherein the at least one enlargement unit can be coupled to the rotating unit and is rotatable with the rotating unit in the coupled state.

9. The device according to claim 8, wherein the rotating station comprises on each side of the rotating unit one enlargement unit.

10. The device according to claim 8, wherein the at least one enlargement unit includes a rotating frame with supporting walls which are inclined towards the vertical.

11. The device according to claim 8, wherein the rotating station comprises two independently drivable conveyor tracks which are a first conveyor track and a second conveyor track, wherein the first conveyor track in a rotated state of the rotating station aligns with the first horizontal conveyor and the second conveyor track in a non-rotated state aligns with the first conveying track of the first horizontal conveyor.

12. The device according to claim 8, wherein the rotating unit comprises a rotating frame having supporting walls being inclined towards the vertical.

13. The device according to claim 8, including a displacement station arranged upstream or downstream of the rotating station by which a glass panel conveyed by the single-track first horizontal conveyor can be moved out of the transport path and can be brought into a parking track enabling a bypassing of a following glass panel.

14. The device according to claim 8, wherein the first conveying track and the second conveying track of the second horizontal conveyor can be driven independently.

15. The device according to claim 8, including a loading station which is assigned to the rotating station.

16. The device according to claim 8, including a loading station which is assigned to the rotatable buffer station.

17. A method for assembling of insulating glass panes from glass panels, the method comprising the steps of:
conveying a pair of glass panels by a single-track first horizontal conveyor to a rotating station;
rotating a first of the two glass panels from the pair of glass panels, which are to be assembled into a glass panel pair forming a glass pane, in the rotating station by 180° and then pairing with a second of the two glass panels;
conveying the assembled pair of glass panels to an assembling and pressing station by a two-track second horizontal conveyor;
assembling of a pair of further glass panels by conveying the pair of further glass panels through the rotating station to a rotatable buffer station; and
rotating a first of the two further glass panels from the pair of further glass panels, which are to be assembled into a further glass panel pair forming a further glass pane, in the rotatable buffer station by 180° and consecutively pairing with a second of the two further glass panels being fed in the rotatable buffer station.

18. The method according to claim 17, wherein the pair of further glass panels having been paired in the rotatable buffer station, include the steps of conveying the pair of further glass panels by the second horizontal conveyor into the assembling and pressing station.

19. The method according to claim 17, wherein the glass panel pair formed by the pair of glass panels is positioned on one side of the assembling and pressing station, and including the step of feeding an additional glass panel into the assembling and pressing station and then assembling the glass panel pair already there with the additional glass panel forming a triple insulating glass pane.
